(19) United States
(12) Patent Application Publication
(10) Pub. No.: US 2009/0125978 A1
(43) Pub. Date: May 14, 2009

(54) APPARATUS AND METHOD FOR MANAGING CONTENTS RIGHT OBJECT IN MOBILE COMMUNICATION TERMINAL

(75) Inventors: Wook-Hyun JEONG, Suwon-si (KR); Jung-Mok BYUN, Suwon-si (KR); Sung-Ki SUH, Suwon-si (KR); Byung-Jo MIN, Suwon-si (KR); Soo-Jin PARK, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/267,819

(22) Filed: Nov. 10, 2008

(30) Foreign Application Priority Data
Nov. 9, 2007 (KR) 10-2007-0114053

(51) Int. Cl. G06F 21/00; H04L 9/00

(52) U.S. Cl. 726/1; 726/3

(57) ABSTRACT

An apparatus and method for managing a contents right object in a mobile communication terminal are provided. In the method, when a system update event occurs, a valid right object of contents in the mobile communication terminal is encoded and the encoded right object is transmitted to a server. A system update is executed and then the server is requested to transmit the encoded right object. The encoded right object is received from the server and the received right object is decoded.

### PRIORITY

This application claims the benefit under 35 U.S.C. § 119(a) of a Korean patent application filed in the Korean Intellectual Property Office on Nov. 9, 2007 and assigned Serial No. 10-2007-0114053, the entire disclosure of which is hereby incorporated by reference.

### BACKGROUND OF THE INVENTION

1. Field of the Invention

The present invention relates to a mobile communication terminal. More particularly, the present invention relates to an apparatus and method for managing a right object of contents based on Digital Rights Management (DRM) technology.

2. Description of the Related Art

As technology has advanced and the performance of mobile terminals has improved, users are demanding the ability to receive and use additional contents through their mobile terminal. With this increased demand for additional contents, Digital Rights Management (DRM) technology has been introduced to prevent the illegal use, distribution and sharing of contents without payment of dues or other fees.

The DRM technology allows a user to purchase the usage rights of contents by paying the price of the contents. The DRM technology is classified into four types depending on the existence types of the rights.

The first type is NoDRM technology that allows the unlimited use of contents. The NoDRM technology gives a user the unlimited usage rights of contents, and the user can transmit the contents to other terminals or PCs.

The second type is Forward Lock (FL) technology that allows the unlimited use of contents in the user's own terminal but forbids transmission of the contents to other terminals or PCs. For example, if a user receives MP3 contents in his own terminal by the FL technology, the user can execute the MP3 contents without limit in his own terminal but cannot transmit the MP3 contents to other users by e-mail or SMS.

The third type is Combined Delivery (CD) technology that allows a contents provider to transmit both the actual contents and the contents usage rights that are purchased by a user. The CD technology provides the rights to use the contents simultaneously with the contents when they are purchased. The rights of contents are classified into a time-dependent right, a right about the number of usage times, and an unlimited right. The time-dependent right allows the unlimited use of contents for a predetermined time from the first execution after purchase of the contents. The right about the number of usage times allows the execution of the contents by the number of times purchased by a user. The unlimited right is the same as the above described FL technology.

The last type is Separate Delivery (SD) technology that allows for providing the contents and providing the rights of the contents in a separate manner. Thus, the contents purchased by a user employing the SD technology can be used only if the rights of the contents are also purchased. Like the CD technology, the SD technology may also define the time-dependent right, a right about the number of usage times, and an unlimited right.

Currently, a mobile terminal may lose the usage rights of contents, obtained with dues payment by a user, because of system updates such as an operating system change, a software update and the like. In this event, the remaining valid usage rights for the obtained contents also disappear and thus the user cannot use even the contents with the remaining valid rights.

As explained above, users can purchase the usage rights of DRM-based contents under various terms based on the DRM type. In the case of the FL technology, there is no obstacle to the continued use of contents after completion of a system update. However, there are problems in the case of purchasing usage rights having various limiting terms. For example, if a user purchases contents on the condition that the user can replay the contents only up to ten times, the rights of five remaining play times must be secured or otherwise compensated to the user when a system update is performed after the contents have already been replayed five times. However, this is not possible. That is, the user cannot secure the previous rights, regardless if the limiting term of contents replay is based on date, time, or an unlimited right (not the case of downloading contents by the FL technology, but the case of purchasing unlimited rights by the SD or CD technology).

The conventional technology imposes restrictions in that a user cannot modify contents in his terminal or transfer the contents to other places by accessing the rights of the contents purchased with payment of dues or other fees. Because of such restrictions, the user may lose the right to use duly-purchased contents during a system update of the mobile terminal.

If the valid rights of the user disappear, the user cannot replay the contents downloaded by the CD technology. Also, if the valid rights of the user disappear, the user cannot replay the contents downloaded by the SD technology until new rights are purchased with the payment of dues or other fees, even though the same valid rights were previously acquired. As described above, the conventional art fulls to provide policies for the compensation and recovery of the available valid rights.

Table 1 summarizes and compares the above four DRM technologies.

TABLE 1

| | | Possibility of | | |
|---|---|---|---|---|
| | Contents | Contents Replay | | |
| DRM | Backup | after System | | |
| Type | Method | Update | Replay Method | Cause |
| NoDRM | Active | Replay Possible | | |
| FL | sync | Replay Possible | | |
| CD | or | Replay | Must download | Right objects of CD, SD |
| | Storage | Impossible | contents after | contents are stored and |
| | Card | | newly | managed separately |
| | | | purchasing the | unlike the contents and |
| | | | contents | the access to the right |
| SD | | Replay | Must receive a | objects is forbidden by |
| | | Impossible | right object by | the spec. Thus, since all |
| | | | SMS, WAP push | the right objects stored in |
| | | | after newly | a right object database are |
| | | | purchasing the | deleted in the event of a |
| | | | right object for | system update, CD, SD |
| | | | contents replay | contents cannot be |
| | | | | immediately replayed |
| | | | | even when backup is |
| | | | | performed. |

Herein, Active Sync, one of the contents backup methods, is a method that synchronizes a terminal with a home device such as a Personal Computer (PC) and transfers the contents of the terminal by using the PC. On the other hand, Storage Card is a method that transfers contents to a storage unit within the terminal. The NoDRM and FL technologies have no usage right object for contents and thus can replay contents even after a system update. On the other hand, the CD and SD technologies transmit a usage right object to a terminal together with the associated contents and store/manage the usage right object and the contents separately. Herein, the contents are stored in an area accessible by the user, while the usage right object is stored in an area inaccessible by the user. Thus, since all the usage right objects stored in a usage right object database are deleted in the event of a system update, the contents cannot be immediately replayed even when the backup thereof is performed.

### SUMMARY OF THE INVENTION

An aspect of the present invention is to address at least the above-mentioned problems and/or disadvantages and to provide at least the advantages below. Accordingly, an aspect of the present invention is to provide an apparatus and method for managing a contents right object in a mobile communication terminal.

Another aspect of the present invention is to provide an apparatus and method for maintaining an available valid right as is in a mobile communication terminal by encoding, before a system update in the mobile communication terminal, a right object through a unique ID of the mobile communication terminal and transmitting/storing the encoded right object in a server and receiving, upon completion of the system update, the encoded right object from the server and decoding the encoded right object through the unique ID.

According to an aspect of the present invention, a method for managing a contents right object in a mobile communication terminal is provided. The method includes encoding a valid right object of contents in the mobile communication terminal, transmitting the encoded right object to a server, executing a system update, requesting the server to transmit the encoded right object, receiving the encoded right object from the server and decoding the received right object.

According to another aspect of the present invention, a method for managing a contents right object in a server is provided. The method includes receiving a valid right object of contents in a communication terminal from the communication terminal, storing the received right object in a directory for the communication terminal extracting, upon receipt of a transmission request for the right object from the communication terminal, the corresponding right object from the directory and transmitting the extracted right object to the communication terminal.

According to still another aspect of the present invention, an apparatus for managing a contents right object in a mobile communication terminal is provided. The apparatus includes a storage unit for storing a valid right object of contents in the mobile communication terminal and a controller for encoding the right object in the mobile communication terminal, for transmitting the encoded right object to a server, for executing a system update, for requesting the server to transmit the encoded right object, for receiving the encoded right object from the server and for decoding the received right object.

According to yet another aspect of the present invention, an apparatus for managing a contents right object in a server is provided. The apparatus includes a directory for a communication terminal for storing a right object of the communication terminal and a controller for receiving a valid right object of contents in a communication terminal from the communication terminal, for storing the received right object in the directory for the communication terminal, for extracting, upon receipt of a transmission request for the right object from the communication terminal, the corresponding right object from the directory of the communication terminal and for transmitting the extracted right object to the communication terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram illustrating configurations of a network and a mobile communication terminal according to an exemplary embodiment of the present invention;

FIGS. 2A and 2B are flowcharts illustrating a method for managing a contents right object in a mobile communication terminal according to an exemplary embodiment of the present invention; and

FIG. 3 is a flowchart illustrating a method for managing a contents right object of a mobile communication terminal in a communication provider server according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and method for managing a contents right object in a mobile communication terminal.

In the following description, the term ‘right object’ refers to information about valid rights of contents based on DRM technology and the right object is stored and managed in a right object database.

Exemplary embodiments of the present invention are divided into two methods depending on the time that is necessary to transmit a right object. The first method is to transmit a right object automatically by a system update manager and the second method is to transmit a right object to a server randomly by a user.

Also, exemplary embodiments of the present invention are divided into two methods according to the processing of a right object remaining in the terminal after the encoding and transmitting of the right object to the server. As will be explained in more detail below, the first method includes deleting the right object from the terminal to prevent the duplication of the right, and the second method includes locking the right object to prevent the use of the right object. Since the right object may full to be transmitted, both of these methods must be performed after receipt of a message informing of the successful completion of transmission of the right object.

Herein, since the use of the right object must be allowed only in the terminal, the right object is encoded using a unique ID of the terminal. Also, using a directory generated according to the unique ID of the terminal, a communication provider manages right objects to be transmitted or received by the user.

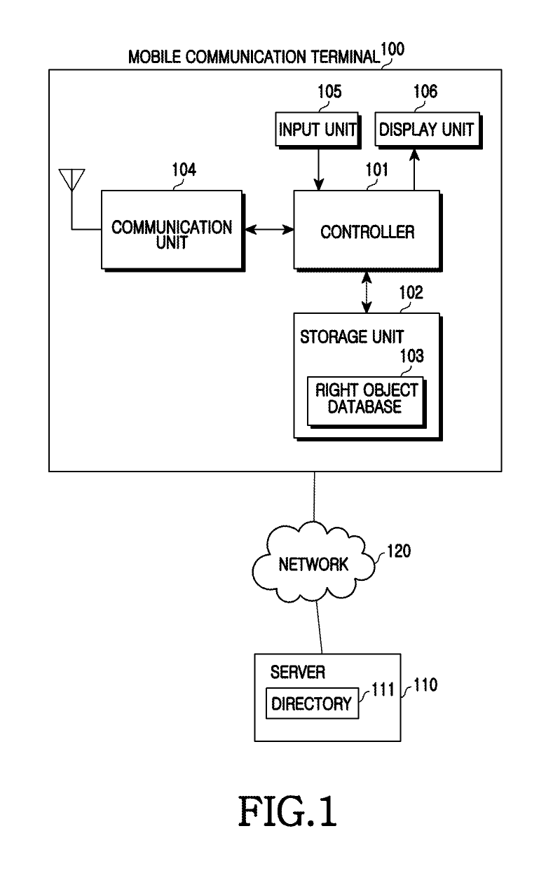

FIG. 1 is a block diagram illustrating configurations of a network and a mobile communication terminal according to an exemplary embodiment of the present invention.

Referring to FIG. 1, a mobile communication terminal 100 includes a controller 101, a storage unit 102, a communication unit 104, an input unit 105, and a display unit 106. Herein, the storage unit 102 includes a right object database 103. The mobile communication terminal 100 is connected through a network 120 to a server 110 of a communication provider, and the server 110 includes a directory 111 for each user.

The controller 101 performs a control/process operation for an overall operation of the mobile communication terminal 100. In an exemplary implementation, the controller 101 encodes, before a system update, a right object through a unique ID of the mobile communication terminal 100 and transmits the encoded right object to the server 110. Also, the controller 101 receives, upon completion of the system update, the encoded right object from the server 110 and decodes the encoded right object using the unique ID.

The storage unit 102 stores various data and programs necessary for the overall operation of the mobile communication terminal 100. In an exemplary implementation, the storage unit 102 includes the right object database 103 to store right objects.

The communication unit 104 processes signals transmitted/received through an antenna. The input unit 105 includes a plurality of function keys, and provides the controller 101 with data corresponding to a key pressed by the user. The display unit 106 displays characters, numerals, and status information generated during the operation of the mobile communication terminal 100. In an exemplary implementation, the display unit 106 may be provided as a Liquid Crystal Display (LCD). In this case, the display unit 106 may include a controller for controlling the LCD, a video memory in which image data is stored and an LCD element. If the LCD is provided as a touch screen, the display unit 106 may perform a part or all of the functions of the input unit 105.

The server 110 generates the directory 111 for the mobile communication terminal 100. In an exemplary embodiment, the server 110 generates the directory 111 in an initial access mode. Upon receipt of an encoded right object from the mobile communication terminal 100, the server 110 stores the received right object in the directory 111 for the mobile communication terminal 100. Upon receipt of a transmission request for the right object, the server 110 extracts the right object from the directory 111 and transmits the extracted right object to the mobile communication terminal 100.

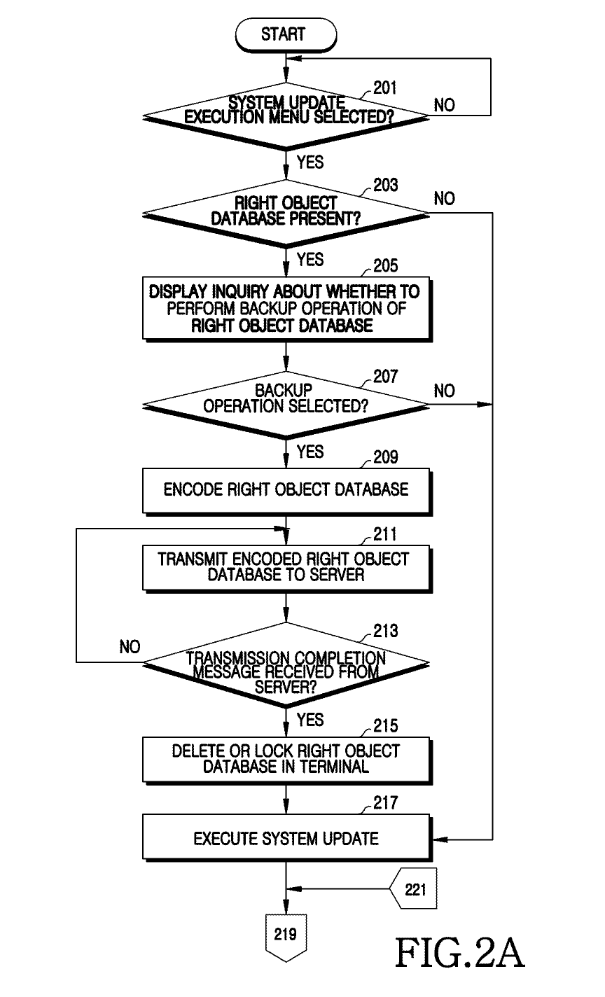

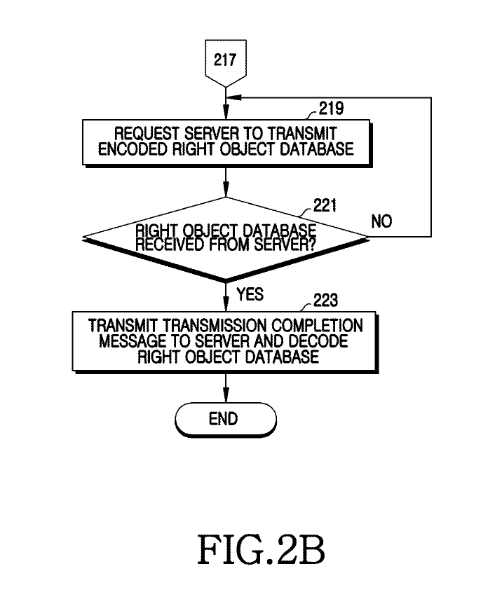

FIGS. 2A and 2B are flowcharts illustrating a method for managing a contents right object in a mobile communication terminal according to an exemplary embodiment of the present invention. Herein, the right object management is performed automatically by a system update manager.

Referring to FIGS. 2A and 2B, in step 201, the mobile communication terminal 100 determines whether a system update execution menu is selected by the user. If the system update execution menu is selected in step 201, the method proceeds to step 203. In step 203, the mobile communication terminal 100 determines whether the right object database 103 is present in the storage unit 102. If it is determined that the right object database 103 is not present in the storage unit 102 in step 203, the method proceeds directly to step 217 to execute the system update.

Alternatively, if it is determined that the right object database 103 is present in the storage unit 102 in step 203, the method proceeds to step 205. In step 205, the mobile communication terminal 100 inquires about whether to perform a backup operation of the right object database 103. In an exemplary implementation, the inquiry may be displayed on the display unit 106. That is, the mobile communication terminal 100 inquires about whether to perform the backup operation by transmitting the right object database 103 to the server 110. In step 207, the mobile communication terminal 100 determines whether the backup operation is selected by the user. If the backup operation is not selected in step 207, the method proceeds directly to step 217 to execute the system update.

Alternatively, if the backup operation is selected in step 207, the method proceeds to step 209. In step 209, the mobile communication terminal 100 encodes the right object database 103 to include the terminal unique identifier (ID). In step 211, the mobile communication terminal 100 transmits the encoded right object database 103 to the server 110 of the communication provider.

In step 213, the mobile communication terminal 100 determines whether a transmission completion message is received from the server 110. If the transmission completion message is not received within a certain time in step 213, the method returns to step 211 so that the mobile communication terminal 100 may retransmit the encoded right object database 103 to the server 110. That is, if the right object database 103 fulls to be transmitted due to network connection problems and the like, the transmission is reattempted at least one more time. In an exemplary implementation, the retransmission attempt may include an inquiry by the mobile communication terminal 100 to determine if the user desires to make the retransmission attempt or if the user desires that the retransmission attempt be stopped.

If the transmission completion message is received from the server 110 in step 213, the mobile communication terminal 100 deletes or locks the right object database 103 in step 215 and then executes the system update in step 217. The deletion or locking of the right object database 103 is to prevent the duplicate use of the right that may otherwise remain in the mobile communication terminal 100. Herein, the deleting or locking operation may be performed in step 215 if the transmission completion message is received from the server 110 in step 213, or may be performed in step 215 without going through step 213 immediately after transmission of the encoded right object database 103 to the server 110 in step 211.

In step 219, the mobile communication terminal 100 requests the server 110 to transmit the encoded right object database 103. In step 221, the mobile communication terminal 100 determines whether the encoded right object database 103 is received from the server 110. If the encoded right object database 103 is not received within a certain time in step 221, the method returns to step 219 so that the mobile communication terminal 100 may again request the server 110 to transmit the encoded right object database 103. If the encoded right object database 103 is received from the server 110 in step 221, the method proceeds to step 223. In step 223, the mobile communication terminal 100 transmits a transmission completion message to the server 110 and decodes the received right object database 103 by means of the terminal unique ID. This enables the user to reestablish the right that was owned before the system update.

Thereafter, the mobile communication terminal 100 ends the process of FIGS. 2A and 2B.

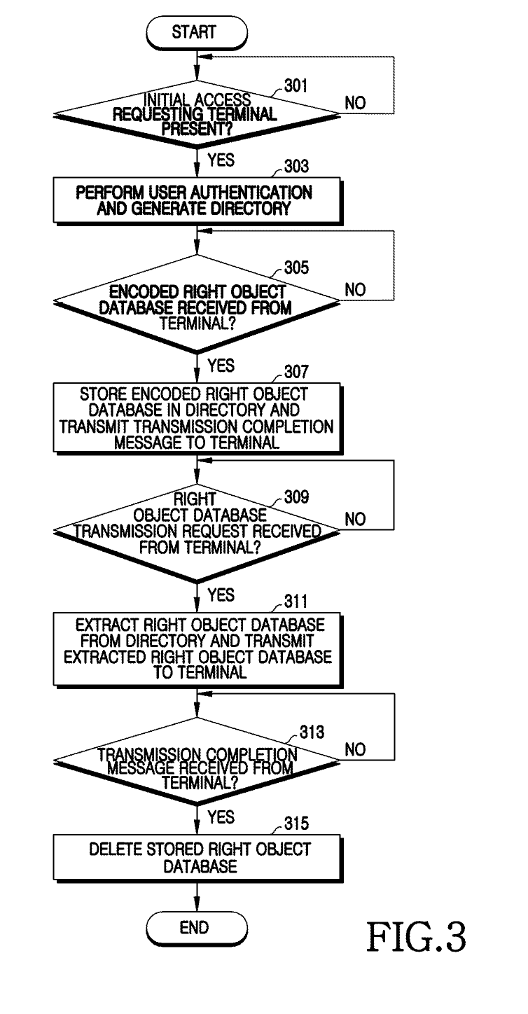

FIG. 3 is a flowchart illustrating a method for managing a contents right object of a mobile communication terminal in a communication provider server according to an exemplary embodiment of the present invention.

Referring to FIG. 3, in step 301, by means of a terminal unique ID, the server 110 determines whether there is a terminal 100 requesting an initial access. If it is determined that the terminal 100 is requesting an initial access in step 301, the method proceeds to step 303. In step 303, by means of the terminal unique ID, the server 110 performs user authentication and generates a directory 111 for managing a right object of the terminal 100.

In step 305, the server 110 determines whether an encoded right object database 103 is received from the terminal 100. If the encoded right object database 103 is received from the terminal 100 in step 305, the method proceeds to step 307. In step 307, the server 110 stores the received encoded right object database 103 in the directory 111 and transmits a transmission completion message to the terminal 100. In another exemplary embodiment, the transmission completion message may not be transmitted.

In step 309, the server 110 determines whether a transmission request for the encoded right object database 103 is received from the terminal 100. If the transmission request for the encoded right object database 103 is received from the terminal 100 in step 309, the method proceeds to step 311. In step 311, the server 110 extracts the encoded right object database 103 from the directory 111 of the terminal 100 and transmits the same to the terminal 100.

In step 313, the server 110 determines whether a transmission completion message is received from the terminal 100. If the transmission completion message is received from the terminal 100 in step 313, the method proceeds to step 315. In step 315, the server 110 deletes the right object database 103 stored in the directory 111 of the terminal 100. Alternatively, if the transmission completion message is not received from the terminal 100 in step 313, the server 110 continues to transmit or retransmits the encoded right object database 103 from the directory 111 of the terminal 100 and transmits the same to the terminal 100.

Thereafter, the server 110 ends the process of FIG. 3.

Exemplary embodiments of the present invention may be performed randomly by the user or may be performed automatically by the manager. In this case, the user may execute the backup of the right at any time. In particular, the random backup by the user is necessary when the system is initialized through hard reset by the user or when the right is not automatically stored by the manager.

An exemplary random backup process executed by the user will be described in more detail below. A right object backup menu and a right object download menu may be present in the terminal 100. If the right object backup menu is selected by the user, the terminal 100 can store its right object in the server 110 through steps 209 to 215 of FIGS. 2A and 2B. If the right object download menu is selected by the user, the terminal 100 can maintain the same right by receiving the right object in the server 110 through steps 219 to 223 of FIGS. 2A and 2B.

As described above, exemplary embodiments of the present invention encode, before a system update in the mobile communication terminal, the right object through the unique ID of the mobile communication terminal and transmit the encoded right object in the server. As also described above, exemplary embodiments of the present invention receive, upon completion of the system update, the encoded right object from the server and decode the encoded right object through the unique ID. Thus, the loss of the right due to a system change such as a system update can be prevented and the available valid right can be maintained as is. Also, the user may perform a backup of his right, thus making it possible to perform a system update at any time and to reduce an unnecessary waste of the right.

Although the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for managing a contents right object in a mobile communication terminal, the method comprising:
encoding a valid right object of contents in the mobile communication terminal;
transmitting the encoded right object to a server;
executing a system update;
requesting the server to transmit the encoded right object;
receiving the encoded right object from the server; and
decoding the received right object.

2. The method of claim 1, wherein the encoding and the decoding of the right object are each performed using a unique identifier (ID) of the mobile communication terminal.

3. The method of claim 1, further comprising, after the transmitting of the encoded right object, deleting or locking the right object in the mobile communication terminal.

4. The method of claim 3, wherein the deleting or locking of the right object is performed when a transmission completion message is received from the server.

5. The method of claim 1, further comprising, before the encoding of the right object:
determining at least one of whether the right object is present in a storage unit and whether a backup operation of the right object is selected; and
executing a system update without the encoding of the right object and without the transmitting of the encoded right object to the server, if it is determined that at least one of the right object is not present in the storage unit and the backup operation of the right object is not selected,
wherein the encoding of the right object is performed if the right object is present in the storage unit and if the backup operation of the right object is selected.

6. A method for managing a contents right object in a server, the method comprising:
receiving a valid right object of contents in a communication terminal from the communication terminal;
storing the received right object in a directory for the communication terminal;
extracting, upon receipt of a transmission request for the right object from the communication terminal, the corresponding right object from the directory; and
transmitting the extracted right object to the communication terminal.

7. The method of claim 6, wherein the right object is encoded with a unique identifier (ID) of the communication terminal.

8. The method of claim 6, further comprising, before the receiving of the right object, performing user authentication for the communication terminal and generating the directory when the communication terminal requests an initial access.

9. The method of claim 6, further comprising deleting the right object stored in the directory upon receipt of a transmission completion message from the communication terminal.

10. The method of claim 6, further comprising transmitting a transmission completion message to the communication terminal after the storing of the received right object.

11. An apparatus for managing a contents right object in a mobile communication terminal, the apparatus comprising:
a storage unit for storing a valid right object of contents in the mobile communication terminal; and
a controller for encoding the right object in the mobile communication terminal, for transmitting the encoded right object to a server, for executing a system update, for requesting the server to transmit the encoded right object, for receiving the encoded right object from the server and for decoding the received right object.

12. The apparatus of claim 11, wherein the encoding and the decoding of the right object are each performed using a unique identifier (ID) of the mobile communication terminal.

13. The apparatus of claim 11, wherein the controller deletes or locks the right object of the storage unit after the transmitting of the encoded right object.

14. The apparatus of claim 13, wherein the controller deletes or locks the right object when receiving a transmission completion message from the server.

15. The apparatus of claim 11, wherein the controller determines at least one of whether the right object is present in the storage unit and whether a backup operation of the right object is selected and executes a system update without the encoding of the right object and without the transmitting of the encoded right object to the server, if it is determined that at least one of the right object is not present in the storage unit and the backup operation of the right object is not selected, wherein the right object is encoded if the right object is present in the storage unit and if the backup operation of the right object is selected.

16. An apparatus for managing a contents right object in a server, the apparatus comprising:
a directory for a communication terminal for storing a right object of the communication terminal; and
a controller for receiving a valid right object of contents in a communication terminal from the communication terminal, for storing the received right object in the directory for the communication terminal, for extracting, upon receipt of a transmission request for the right object from the communication terminal, the corresponding right object from the directory of the communication terminal and for transmitting the extracted right object to the communication terminal.

17. The apparatus of claim 16, wherein the right object is encoded with a unique identifier (ID) of the communication terminal.

18. The apparatus of claim 16, wherein, when the communication terminal requests an initial access, the controller performs user authentication for the communication terminal and generates the directory.

19. The apparatus of claim 16, wherein the controller deletes the right object stored in the directory when a transmission completion message is received from the communication terminal.

20. The apparatus of claim 16, wherein the controller transmits a transmission completion message to the communication terminal after the received right object is stored.
